(19) United States
(12) Patent Application Publication
(10) Pub. No.: US 2004/0243508 A1
(43) Pub. Date: Dec. 2, 2004

(54) Systems and methods for automating credit counseling and debt management programs

(76) Inventors: James A. Samson, Temecula, CA (US); Benjamin H. Lacomble, Vista, CA (US)

Correspondence Address: ROBERT J. DEPKE LEWIS T. STEADMAN, HOLLAND & KNIGHT LLC, 131 SOUTH DEARBORN, 30TH FLOOR, CHICAGO, IL, 60603, US

(21) Appl. No.: 10/449,574

(22) Filed: May 30, 2003

(51) Int. Cl. G06F 17/60

(52) U.S. Cl. 705/38; 705/40

(57) ABSTRACT

Credit management systems and methods are disclosed that efficiently and automatically manage a high volume of credit counseling agencies' work, store flexible rules and relationships between creditors and clients, automatically implement rules universally, automatically process payments and disbursements based on the rules, and maximize fairshare to credit counseling agencies. The credit management system comprises a database tier, a business tier, and a presentation tier. The system assigns various groups of tasks to various modules, programs. The first contact module, the appointment schedule module, the counseling module, the creditor management module, the proposal submission module, the payment and disbursement module, and the action management module all perform various tasks based on universal and particulars rules.

### BACKGROUND OF THE INVENTION

1. Field Of The Invention

The present invention relates, in general, to the field of credit counseling and debt management. More specifically, the present invention is directed to systems and methods which electronically collect client information and creditor information in order to assist in automatically processing payments and disbursements. Additionally, the systems and methods may be used in automatically managing a credit agency's work schedule.

2. Description of the Related Art

In recent years due to the changing economic climate there have been increasing incidents of foreclosures, bankruptcies and other non-payment of debt obligations. There has been significant growth of credit card and other forms of debts. For example, the United States Payment Center has stated that an average individual has $8,000 of credit card debt in addition to other financial obligations such as home mortgages, student loans and car loans. As a result of changing financial conditions, many individuals increasingly require credit counseling agencies to aid in the management of their financial burdens.

Traditionally, credit counseling agencies collect client information, negotiate with a client's creditors and set up payment plans or schedules. These agencies help creditors receive payments and prevent client defaults. In turn, they receive what is known as fairshare from creditors which is a portion of clients' regular payments.

The dramatic increase in the need for credit counseling services has resulted in the recognition of several significant shortcomings of credit counseling and debt management systems. Existing systems cannot handle the increasing work load, are inefficient in the handling of disbursements and payments. Furthermore, the existing systems do not meet clients' demands for access and quick processing, and do not maximize fairshare to the agencies. The current systems are simply unable to meet the demands of today's credit counseling agencies.

One significant deficiency is that existing credit counseling and debt management systems are unable to handle increasing work loads. These conventional systems cannot efficiently manage a credit agency's work schedule. For example, existing systems are unable to track credit counselor appointments based on factors such as language abilities, clients' specific needs and location of counselor with respect to client, etc. Current systems employed by credit counseling agencies require that an individual making an appointment for a client to be aware of these factors and manually manage work schedules of the credit counselors by personally considering these factors. This approach is extremely inefficient. For instance, many appointment schedulers do not realize that certain appointments take longer than others and therefore make appointments without considering these factors and the counselor's and client's needs. As a direct result, important resources such as time are spent in not only identifying and scheduling the work but also re-adjusting counselor schedules and re-scheduling clients. In addition, existing systems cannot schedule essential tasks based on the particular services a client needs or desires. For example, under existing systems, credit counseling workers must manually assign and validate even routine tasks such as generating client consent forms and payment verifications. As more client accounts are created, sometimes these tasks are inadvertently overlooked leading to mismanagement or even a creditors' dismissal of client accounts. Hence, existing systems are unable to manage the increasing work that credit agencies have received.

Moreover, existing systems and methods are inefficient in handling payments and disbursements. Currently, payment and disbursement information is entered into the system, which then processes the information according to the defined rules. However, when a payment is insufficient, such as when a client only makes a partial payment, the credit agency's payments to all creditors and disbursements are negatively impacted. In this situation, all creditors are paid less than the minimum payment. This is known as shorted payments. This is not an uncommon situation. In fact, clients are sometimes unable to make the full payment as a result of loss of employment, divorce, or health issues. Shorted payments are undesirable because some creditors may be more important than others, thus full payments to those creditors at the expense of other creditors are preferred. Additionally, typically two shorted payments will place the client in default of the payment plan thereby creating the risk that he/she will no longer be able to enjoy the benefits of a debt management agreement with his/her creditors. Current systems are inflexible with respect to payments and disbursements as changes to the formulas must be manually entered each time any deviation occurs from the original obligation. In addition, they do not disburse payments according to preferences or in rotations which could eliminate some of the problems encountered with shorted payments. It is clear that existing systems are inefficient with respect to the handling of payments and disbursements.

In addition, existing systems and methods do not meet clients' needs for quick access and efficient processing of information. Increasingly, clients want instant access to their information and desire to be regularly updated about their accounts. Under current systems, this information is only available when the client is able to contact his/her counselor and retrieve the information from the counselor. Furthermore, clients require that their information, payments and disbursements be managed quickly and efficiently in order to improve their credit scores. This is important because clients need to show an improvement in their credit as well as a good credit history in order to obtain services and products such as mortgages, car loans and even employment. However, under existing systems, clients' payments and disbursements typically are verified and processed by several different departments. When there is a discrepancy between a clients' payments and his/her credit report, several departments must also be contacted to verify that the payment was (1) collected (2) processed and (3) accepted or rejected. This results in an inexcusable delay, especially when the client requires a timely disclosure to acquire loans or services. Therefore, existing systems do not provide the quick access and efficient processing of payments that clients usually require.

Finally, conventional systems are not optimized to provide fairshare to credit counseling agencies. Fairshare is the most important and sometimes the sole source of income for credit counseling agencies. Recently, fairshare to credit counseling agencies has been decreased by creditors because an increasing number of individuals have started utilizing these agencies. Therefore, it is imperative that credit counseling agencies be able to maximize their fairshare. In conventional systems, inefficient handling of payments and disbursements and inefficient management of time results in decreased fairshare for credit counseling agencies.

The present invention overcomes the shortcomings and deficiencies of the prior art and is directed to systems and methods which solve or at least substantially reduce the impact of these problems associated with existing credit counseling and debt management systems.

One object and advantage of the present invention is to provide a system that collects comprehensive information about clients to determine their needs, desires and the agencies' ability to assist clients.

It is another object and advantage of the present invention to provide a system that effectively manages a high volume of counselor workload.

It is further an object and advantage of the present invention to provide a system that efficiently manages counseling work among various branches of an agency.

It is still further another object and advantage of the present invention to provide a system that accurately defines creditor relationships and automatically implements changes for all relevant clients.

It is yet another object and advantage of the present invention to provide a system with flexible payment schedules and client relationships.

It is still further another object and advantage of one embodiment of the present invention to provide a system that is flexible in disbursement schemes.

It is an additional object and advantage of the present invention to provide a system that maximizes fair share for the agency.

The above and other objects, advantages and features of the present invention will become readily appreciated and understood from consideration of the following detailed description of the preferred embodiments of the present invention when taken together with the accompanying drawings of the present invention.

### SUMMARY OF THE INVENTION

In accordance with the foregoing objects, the present invention comprises systems and methods for managing and processing credit counseling agency work schedule as well as payments and disbursements. The systems and methods of the present invention are extremely flexible and are easily capable of handling and processing increasing amounts of workload.

In accordance with a preferred embodiment of the present invention, credit counseling and debt management systems and methods employ groups of servers in order to more efficiently handle and process client information, creditor information, payments, disbursements and agency work schedules. However, those skilled in the art will appreciate that even a single server could be utilized depending upon the size of the agency and the number of tasks to be performed. In the preferred embodiment, a first group of servers, the database tier, contain databases to store creditor information, client information and other information. This group of servers preferably contains relational data, i.e. data showing the relationship between various creditors as well as clients.

A second class or group of servers, the business tier, collects and processes data from the database tier. This group of servers performs complicated data validation, analyzes data based on business rules and allows the same rules to be implemented across all modules. For example, this group generates reports, validates data and processes payments and disbursements based on the defined rules. Furthermore, this tier can process the data so that it is displayed in a user friendly format.

In a further preferred exemplary embodiment yet another group of servers, the presentation tier, renders pages and presents the data to users and clients. At this level, a simple data entry validation occurs. For example, the presentation group of servers is responsible for rendering the pages on the web site and displaying the information requested by users and clients.

The systems and methods of the present invention are extremely flexible and provide the ability to add multiple servers for each function therefore providing infinite scalability. They are also very efficient and are capable of performing tasks in very short periods of time. It will be recognized by those skilled in the art that the systems can utilize resources of a single-server or single group of servers for performing the same tasks. However, in order to achieve maximum efficiency, it is preferred that multiple groups of servers are utilized for performing dedicated tasks.

In one embodiment of the invention, the systems and methods allocate and assign different groups of tasks to different modules. In accordance with a preferred exemplary embodiment of the present invention, seven modules are provided. The modules are: the first contact module, the appointment schedule module, the counseling module, the creditor management module, the proposal submission module, the payment and disbursement module, and the action management module. The modules are utilized to efficiently handle and process the agency's workload. Persons skilled in the art will also realize that allocation of tasks into various modules can also provide security because users', i.e. persons with access to the system, rights may be limited to certain modules. For example, a telephone operator can have access to the first contact and schedule modules but may not enter payment and disbursement information within the disbursement module. It will be appreciated by those skilled in the art that the various modules may also be combined into one or more compound modules. For example, first contact and appointment scheduler can be within one module. In the present invention, each individual module provides its unique advantages over conventional systems.

The first contact module provides uniform scripts to assist individuals in obtaining client information. It records basic client information and automatically generates new scripts based on the clients' answers to the previous scripts. This substantially increases efficiency because the system determines clients' needs and automatically provides all options available to the client. In addition, it allows an operator to accurately present information and assist the client. As a result, time and resources are spent assisting the client rather than manually evaluating each client's needs and researching his/her options. Moreover, accurate identification of a client's needs results in increased client retention.

The appointment schedule module centralizes management of counselor work schedules. The appointment scheduler automatically provides counselors' available time based on several factors such as their expertise in particular areas, their availability, their language skills, and their location. Furthermore, it automatically adjusts the counselors' schedules based on a client's needs such as language skills, handicaps and the breadth of counseling required. Additionally, the scheduler allows operators and other users to distribute appointments to other counselors or to entire groups. For example, if a counselor is unable to attend his or her scheduled appointments, the module allows an operator to assign the appointment to another counselor or another group of counselors. Finally, the scheduler automatically rotates branch offices designated as “on-demand counselors” based on the day as well as the availability of the counselors at the particular branch. Hence, the schedule module accurately distributes appointments based on clients' needs. Therefore, the present invention dramatically increases efficiency and provides advantages over conventional systems. More realistic and efficient scheduling is thus achieved.

The counseling module allows a counselor to obtain specific information based on the client's needs determined by the first contact module. In addition, it assists the counselor in providing specific solutions to the client. Specifically, the counseling module allows a counselor to collect information regarding assets of the client, their creditor summary, their budget, their credit report and their counseling needs. As this information is gathered, the system automatically notifies the counselor that certain authorizations are required in order to better assist a client. For example, the system automatically generates a credit report waiver for the client so that the agency may obtain the client's credit report. At the end of the counseling session, the system summarizes the results of the session and reviews the next steps for the client. It provides actions and recommendations for the client based on the client's budget. It also generates letters for the collection of fees, documentation, instructions and the completion of authorization forms. Based on the client's choice of solutions, the system automatically generates sum totals of the fees. It is also within this module that the client is able to sign up for a debt management plan or other agency services such as credit correction, taxes, settlement and first time homebuyer help.

The creditor management module collects, processes and stores creditor information and implements the information throughout the system. The creditor management module defines creditor relationships and implements concessions, fair shares and payment rules throughout the system. The present invention defines creditor relationships in a hierarchical manner. This is advantageous because creditors in the industry form such hierarchical relationships and utilize the same rules within a hierarchy. For example, one bank owns and distributes several credit cards under different names. Nonetheless, the same payment, concession, and fairshare rules are utilized for all of those credit cards.

The present invention allows an individual to implement a change at a higher level in the hierarchy and automatically implement the same changes and payment rules within the rest of the hierarchy. Nonetheless, the system is sufficiently flexible so that an individual client and an individual creditor can still retain his or her own payment and concession rules without disturbing the relationship between the entire hierarchy. This is important because the system can manage a client's information and payment schedule accurately. In addition, it sustains revenues for the agency. Specifically, if payments to the creditor are made based on incorrect information, not only is the client unable to keep a regular payment history but the creditor also reduces or completely negates fairshare to the agency. Therefore, the present system provides advantages over conventional systems that are inflexible with respect to payment and other rules.

The proposal submission module processes and generates proposals on behalf of the client to the creditor. This module automatically processes client income information and asset information as well as creditor payment and concession rules in order to generate a proposal. It summarizes a client's budget and implements concessions in fairshare rules in order to provide a payment schedule for the client. The system has the ability to send the proposals electronically to the creditor or to generate a written report in order to be send it through regular mail. Furthermore, the system is sufficiently flexible to automatically determine whether a proposal was accepted or rejected based on creditor rules. For example, certain creditors are deemed to have accepted a proposal if no explicit rejection is sent. In such instances, the system automatically initiates a payment schedule when no explicit rejection is entered.

The payment module automatically processes payments and disbursements based on client income information, assets information and creditor fairshare, concession, and payment rules. In one embodiment of the invention, the system generates payment plans for clients based on their payroll schedule. The system debits a client's checking account for the entire payment or collects the sum payment from several different sources. Once the disbursement date is realized, the system automatically disburses the payment based on fairshare and payment rules. Therefore, the system is able to take one lump payment from the client or combine various payments from various sources for the client and disburse the total payment according to the creditor rules and client's payment plans. If the client's payment is insufficient to pay the all of the creditor obligations, the system automatically identifies the relative importance of each payment and either gives preference to certain creditors or distributes evenly across the board. In addition, in these instances where the client chooses to pay certain creditors first, the system automatically makes overpayments to those creditors. In addition, the system can also be altered to automatically pay down the smaller accounts prior to making over payments to larger ones. This results in more rapid elimination of certain credit accounts which is desirable.

This flexibility is advantageous over conventional systems because they require that specific formulas and specific disbursements be set out for each individual creditor in order for the system to process the payments. In conventional systems, all creditors receive less than the minimum payment, shorting, when a client is unable to meet the fixed minimum payment.

Another advantage of the present system is it's ability to rotate payments in order to avoid shorting the same creditor in consecutive months. Here, the system automatically rotates the creditor which receives less than the minimum payment each month. This is important because two consecutive months of nonpayment or short payments within the industry negates the payment plan and places the client in default. The present invention avoids such problems and shortcomings of the conventional systems.

The payment and disbursement module also processes fairshare rules. The system is flexible in terms of deducting fairshare amounts from the initial payment or electronically accepting payments from the creditors. The system can also be defined to receive fairshare payments through regular mail. This process maximizes fairshare and generates regular revenue for the credit counseling agency.

The action management module of the present invention also provides advantages over conventional systems. The module allows users to collect, track, and process various administrative tasks throughout the agency. Tasks such as creditor payment verification, fair share rule changes, client credit report alterations may all be allocated to specific individuals or to entire groups. The system also automatically assigns certain tasks such as, verification of changes in the creditor payment rule, to an individual or to an entire group. Therefore, the present system distributes work to available users and increases efficiency.

Those skilled in the art will appreciate that the preferred exemplary embodiment employs all of the modules but it will be recognized that only one or several modules may be implemented in an alternative embodiment.

### BRIEF DESCRIPTION OF THE DRAWINGS

FIG. 1 shows a block diagram of hardware included in the system;

FIG. 2 shows a block diagram of hardware included in one embodiment of the system;

FIG. 3 depicts the modules within the system;

FIG. 4 is a workflow diagram of the first contact module;

FIG. 5 is a workflow diagram of the appointment schedule module;

FIG. 6 depicts the client detail section of the counseling module;

FIG. 7 depicts the home buyers/owners section of the counseling module;

FIG. 8 shows a block diagram of the creditor hierarchial relationships;

FIG. 9 shows a block diagram of the servicer relationships;

FIG. 10 shows a block diagram of the full budget proposal section;

FIG. 11 is a workflow diagram of the declined proposals section.

### DETAILED DESCRIPTION OF THE INVENTION

While various embodiments of the present invention are discussed in detail below, it should be appreciated that the present invention provides inventive concepts that can be embodied in wide variety of specific contexts. The specific embodiments discussed are merely illustrative of specific ways to make and use the invention and do not limit the scope of the invention.

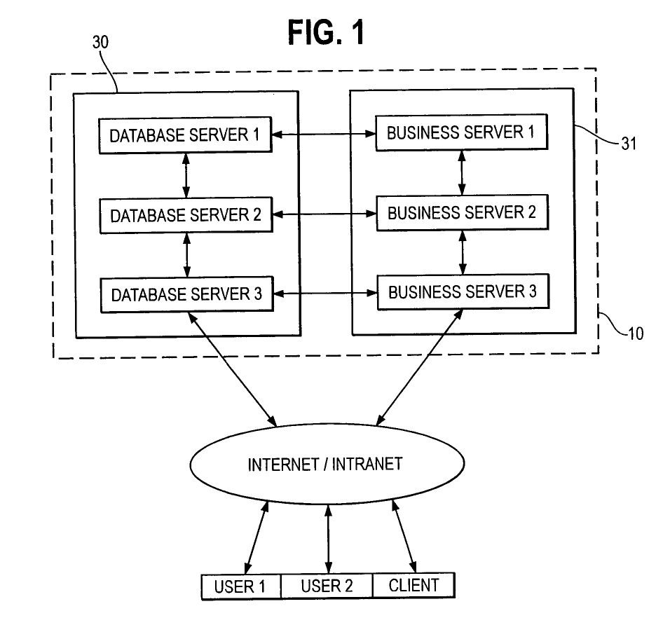

Turning first to FIG. 1, there is shown a preferred exemplary embodiment of the present invention. In accordance with the preferred embodiment the credit counseling and debt management system employs several groups of servers in order to more efficiently handle processing of client, creditor, counseling, payment, and disbursement information. A first exemplary embodiment is shown at 10 in FIG. 1. As shown in FIG. 1, a first plurality of servers referenced as the Database Tier 30 are linked with a second plurality of servers 31. The first group of servers designated as the Database Tier 30 provides storage for databases containing various client information, creditor information as well as users' action logs. The Database Tier 30 maintains data preferably according to its relationships to client, creditor, payment, disbursement, and fairshare rules. It preferably maintains these relationships across all of the relevant modules. For example, the Database Tier 30 links the payment rules of a particular creditor to all the clients of that creditor.

The second group of servers to which the database tier is linked is designated as the Business Tier 31. In the preferred embodiment, the Business Tier 31 collects and processes the data from the databases. The Business Tier 31 performs complicated data validations based on several rules and industry customs. For example, the Business Tier 31 defines and validates the percentage of fairshare to the counseling agency based on the percentage an agency receives from that particular creditor for the amount of clients it serves. Finally, the Business Tier 31 implements the rules across the entire system.

The Business Tier 31 preferably contains the majority of the modules which are used in manipulation and processing of client information, creditor information, payments, disbursements, and fairshare rules. In the preferred embodiment of the invention, the software allocates different groups of tasks to different modules, programs that collect, store, or process data, in order to increase efficiency. The specific modules are described in more detail below.

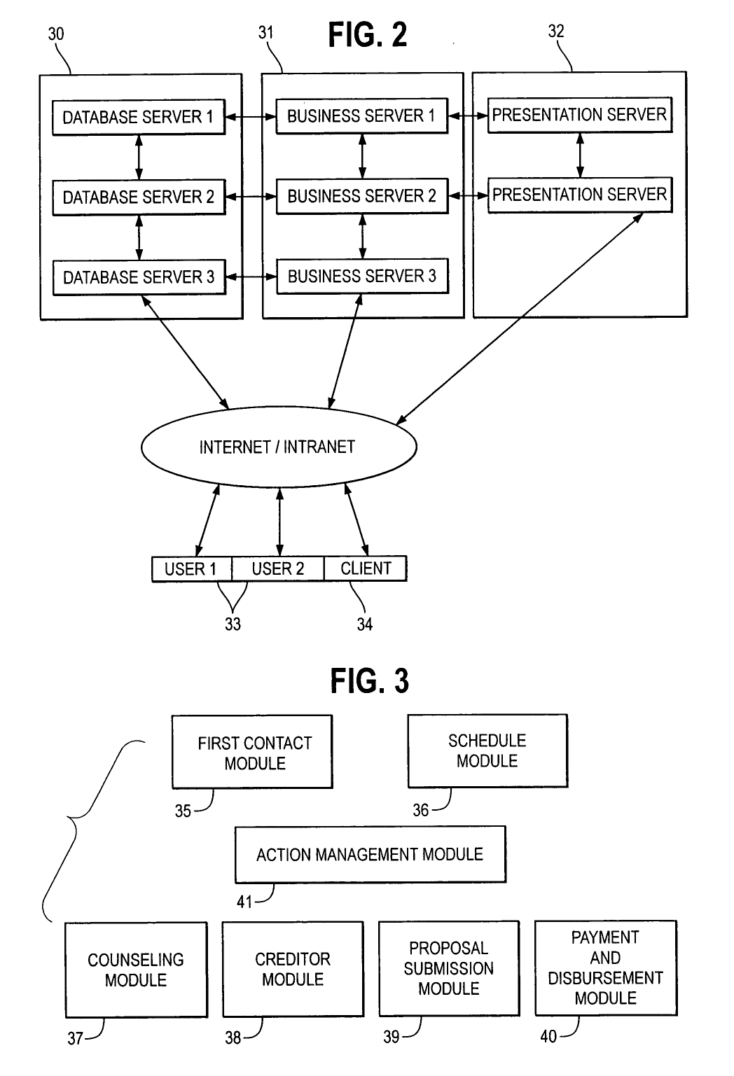

The preferred embodiment of the invention employs yet another group of servers known as the Presentation Tier 32 (see FIG. 2). The Presentation Tier 32 renders pages to users 33 and clients 34. In addition, it processes simple data entry validation. For example, the Presentation Tier 32 checks to see whether the field requiring an amount is actually populated by a numerical value rather than a alphabetic or alphanumeric value.

It should be recognized that the embodiments set forth here are exemplary only and that many variations of the structures set forth may be employed but which still utilize the teachings of the present invention. For example, although the preferred embodiment indicates that there are plurality of database servers, it is possible that a single server can be utilized in conjunction with a single business server. Furthermore, the Database Tier or the Business Tier can alternatively be embodied as a single computer with access to the client and creditor information. In another exemplary embodiment, the functions of the Presentation Tier may also be allocated to the Business Tier. Moreover, the various tiers may be physically located in different locations and connected via direct connections, the internet, intranet or a virtual private network.

The systems and methods of present invention are extremely flexible and provide the ability to add multiple servers for each function thereby providing virtually infinite scalability with respect to the amount of client information, creditor information, payments and disbursements which can be simultaneously processed by the system. The systems and methods of the present invention are also very efficient and are capable of performing these tasks in a very short period of time.

In a preferred embodiment of the system, the Database Tier logs all changes as well as the user who edited or changed the information within each module. This allows the credit counseling agency to automatically track, identify, validate and ascertain the reason for changes from its source. This is advantageous because it allows the credit counseling agencies to settle any disputes or discrepancies and accurately manage credit counseling information.

Turning now into FIG. 3, the system allocates various groups of tasks to different modules. In the preferred embodiment, seven modules, known as the first contact module 35, the appointment schedule module 36, the counseling module 37, the creditor management module 38, the proposal submission module 39, the payment and disbursement module 40, and the action management module 41, are utilized. Each module contains pre-designed pages with fields for relevant data entry. In addition, the modules contain menus that allow users to access other modules and pages.

Significantly, it should be realized that separation of tasks to different modules provides security because the agency is able to determine which individual access which modules. This is particularly desirable because the database servers which contain proprietary information can be controlled more tightly. Nonetheless, the agency may allow various information to be viewed by various individuals.

Yet another advantage of the system of the preferred embodiment is a substantial increase in efficiency. The processing time is significantly reduced when the information desired may be obtained simply from the creditor and client module rather than after a search of all files throughout the entire system. In addition, damage or alteration to one module may be handled without damage or alteration to other modules. Hence, the preferred embodiment of the present invention has several advantages over conventional systems.

First Contact Module

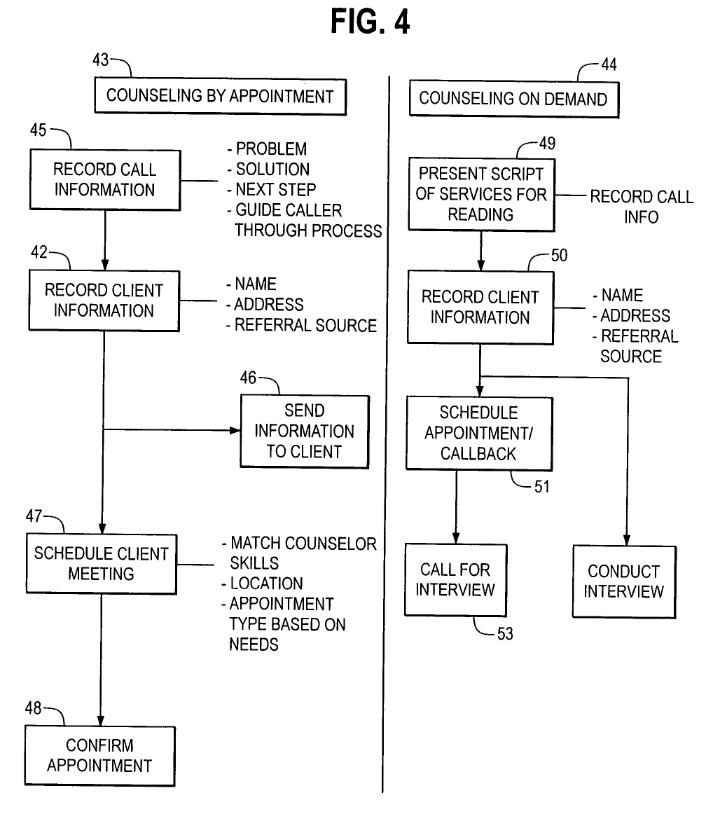

As shown is FIG. 4, the First Contact Module collects and processes information when a client first contacts the credit counseling agency and desires to schedule an appointment. The First Contact Module workflow is further divided into two sections, counseling by appointment 43 or counseling on demand 44. Counseling by appointment 43 refers to the scenario where a client desires to schedule an appointment at a later time. On the other hand, counseling on demand 44 refers to the scenario where the client desires to conduct an appointment during the actual call. The system automatically implements a different workflow based on the particular scenario.

When counseling by appointment is desired, the operator records call information into the system during a first step 45. The system provides pre-designated scripts for the operator to read to the client. The system guides the operator and the caller through the process by utilizing various scripts and questions. Based on the answers, the system automatically determines the caller's problem, the caller's solution, and the next steps the caller should take. For example, the system may determine that a caller needs a debt management plan based on responses to the questions. The system provides that a debt management plan may be the best solution for a client and states that the client needs to set up an appointment with a counselor in order to set up the debt management plan.

Based on the caller's information, the system may determine that the agency is unable to handle the caller's specific problems. In this case, the system automatically generates referral sources authorized by the agency that can address the client's needs. The system tracks referral sources and the number of referrals that the agency has sent to a particular source. The system also generates information such as referral letters that can be sent to the client. The system then allows the operator to schedule an appointment for the client during a step 47. During a final step 48, the system allows the operator to confirm an appointment with the present client or a previous client.

In the case where a client desires counseling on demand 44, the system allows the operator to read scripts of services that the agency provides at a step 49. Thereafter, it allows the operator to record caller information such as name, address and referral source at a subsequent step 50. As a next step 51, the system displays schedule information of all available counselors within the designated branch for the day. If a counselor is available at the desired time, the system allows the operator to transfer the caller to the counselor. If no counselor is available, the system allows the operator to schedule an appointment and a call-back for the client on the same day at a final step 53.

The system lists counselors based on the counselor's skills, client's or counselor's location, and the appointment type required by the client. The module then automatically adjusts the relevant counselor's schedule accordingly. Implementation of this process by the system assures that the caller or the client is provided with compressive information about the agency. All the necessary information is accurately collected from the client. Therefore, the system provides uniformity in handling client's as well as enhanced client retention for the credit counseling agency.

Appointment Schedule Module

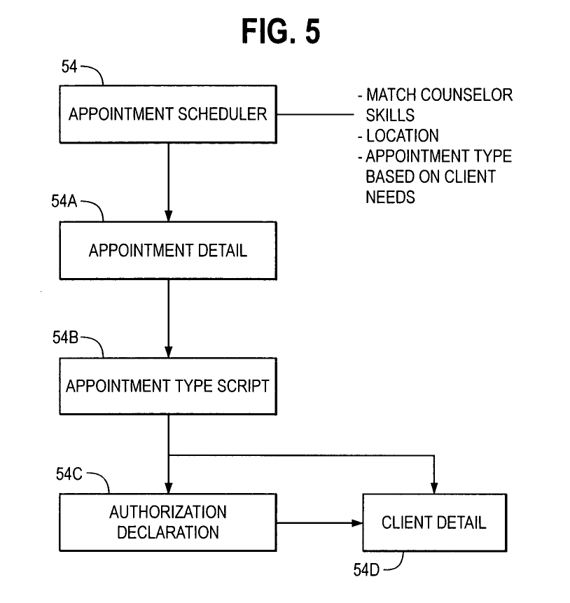

FIG. 5 displays the work flow process by the Appointment Schedule Module. The Appointment Schedule Module automatically generates lists of all available appointments of particular counselors based on several criteria at a sequence point 54. First, the system generates this list based on the client's particular needs. In addition, it provides only those appointments which are available during the desired times by the client. Moreover, it only presents those counselors with the necessary skills to meet the client's needs. The system also bases the list of every available counselor on the location of the counselor in relation to the client, the availability of counselors within a certain location, and on the basis of whether the client desires a face to face appointment or a over the phone appointment. Furthermore, the Appointment Schedule Module adjusts the appointment based on the client's desired language of communication, client's handicaps, and the client's particular problems. The Appointment Schedule Module greatly increases efficiency because it automatically generates available counselors and appointment schedules. Finally, the system automatically updates counselor's work schedules and automatically generates client and counselor reminders via e-mail or through print confirmation cards.

Appointment detail information is generated in step 54A. Based on the appointment detail information a script that is related to the detail information is generated in step 54B. An authorization declaration is received in step 54C and client detail information is acquired in step 54D.

Counseling Module

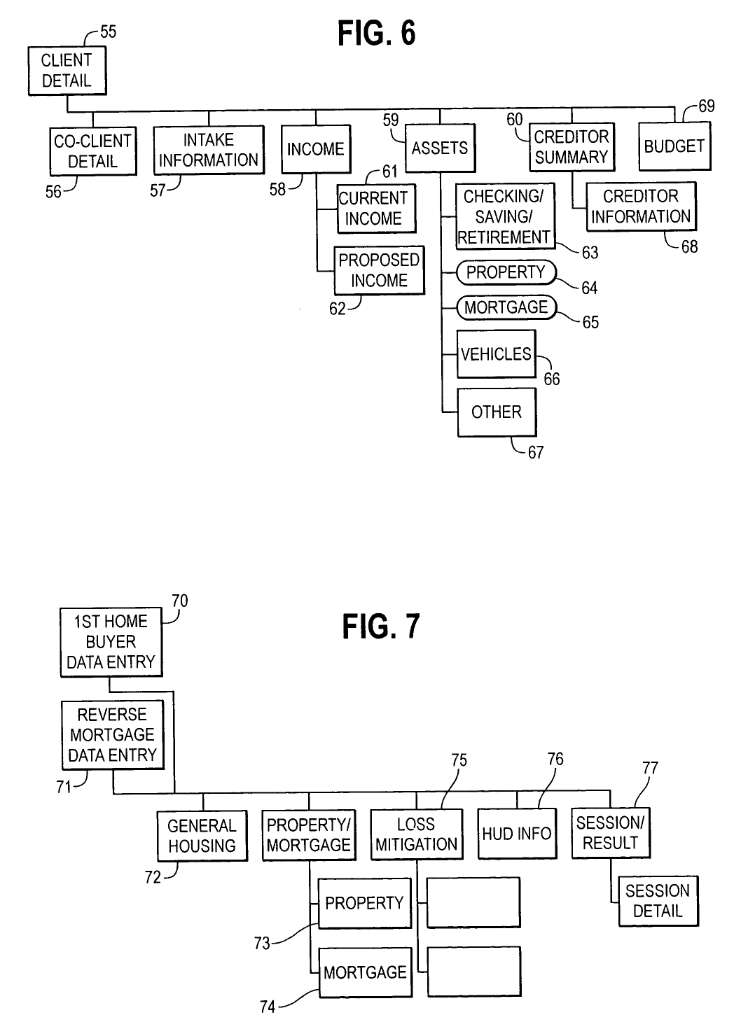

The Counseling Module assists the counselor in collecting detailed information about the client such as his or her creditor information, housing information, and any other information relevant to the client's needs. As the counselor and the client follow the procedures set forth by the system, the system automatically validates and saves data ascertained from the previous scripts. FIG. 6 displays the sequence of events for one aspect of the counseling module, the client detail aspect 55. The client detail aspect assists the counselor in collecting detailed information about the client such as client's name, address, employment history, spousal information at a point 56, intake information at a subsequent point 57, income information at a next point 58, client's assets at a further point 59, and his or her creditor summary at a final point 60. In addition, the system does not allow a counselor to progress from one set information or from one page to the next page without having answered the appropriate fields.

With particular information such as income information, the system requires that the counselor enter current income information at an intermediate point 61 based on employment, current rental property and other assets such as trust accounts, funds and stocks. In addition, it allows the collection of proposed income information from the client such as from future settlements, future dividends, retirement accounts, etc. at a point 62 after current information is collected.

Further, the module first collects information about client's checking, savings and retirement accounts during an event 63, about client's property or properties during a next event 64, about client's mortgage(s) during a subsequent event 65, about client's vehicles during a following event 66, and about other assets during a final event 67. The module directs the counselor to enter creditor summaries as provided by the client. If the client is able to provide specific creditor information, such information is also entered into the system at a point 68. Based on collected information, the system automatically generates a client's budget at a final step 69.

When the client requires counseling for housing, the system assists the counselor in collecting comprehensive information about the client's housing. Referring to FIG. 7, the system first prompts the counselor to enter general housing information at a first step 72. Next, the system allows the counselor to collect information specifically about the property at a second step 73 and the client's mortgage at a third step 74. If available, the system also allows the counselor to collect information about loss mitigation during a fourth step 75. Moreover, information from the housing and urban development is also collected during this stage during the HUD step 76. Finally, the system processes the entire information and provides a session result at a final point 77 to both the counselor and the client. The result provides information containing the debt management proposal based on the received data as described below.

The Counseling Module allows a counselor to capture information from the client and enroll him or her into a debt management plan. First, the counselor collects general creditor information from the client and inputs the same into the system. Next, the counselor chooses creditors from the creditor matrix policy. The creditor matrix policy lists all creditors within the system. The system allows a counselor to look up the creditor via creditor name, partial name search, credit card, issuer or the servicer. Once a creditor is chosen, the counselor then adds client debt details in reference to the creditor. The counselor also defines the first payment date by the client, the frequency with which the client will make payments and specific comments from the client about the creditor. When all the data is entered, the system automatically determines a client's tentative payment plan based on the adjusted balance determined from the client's assets and accounts, the client's proposed payments, the payment methods as well as fees for the payment plan.

In the preferred embodiment, the system then automatically generates and assigns new tasks to a separate department within the agency to verify the creditor information and the creditor's relationship to the client. Utilizing a separate department to verify the creditor and client relationship allows the agency to effectively manage client information and accurately disburse payments. This is important because often times clients receive statements from one creditor, however, that creditor acts on behalf of another creditor or agency. Initiating another step to verify creditor and client relationship ensures that the client's funds are disbursed appropriately. Once this department verifies the creditor and client relationship, the system automatically defines a regular payment schedule, adjusts the client's balances within the client information module and implements proposed payment, disbursement and fair share rules for the agency.

After a debt management plan is set for the client, the particular account cannot be edited without validations. However, at the end of the plan cycle, the system automatically cancels the client account and generates letters to verify that the client has made regular payments and has successfully completed the plan. Thus, the counseling module allows a counselor to obtain specific information about the client and efficiently and accurately service the client's debt management needs.

Creditor Management Module

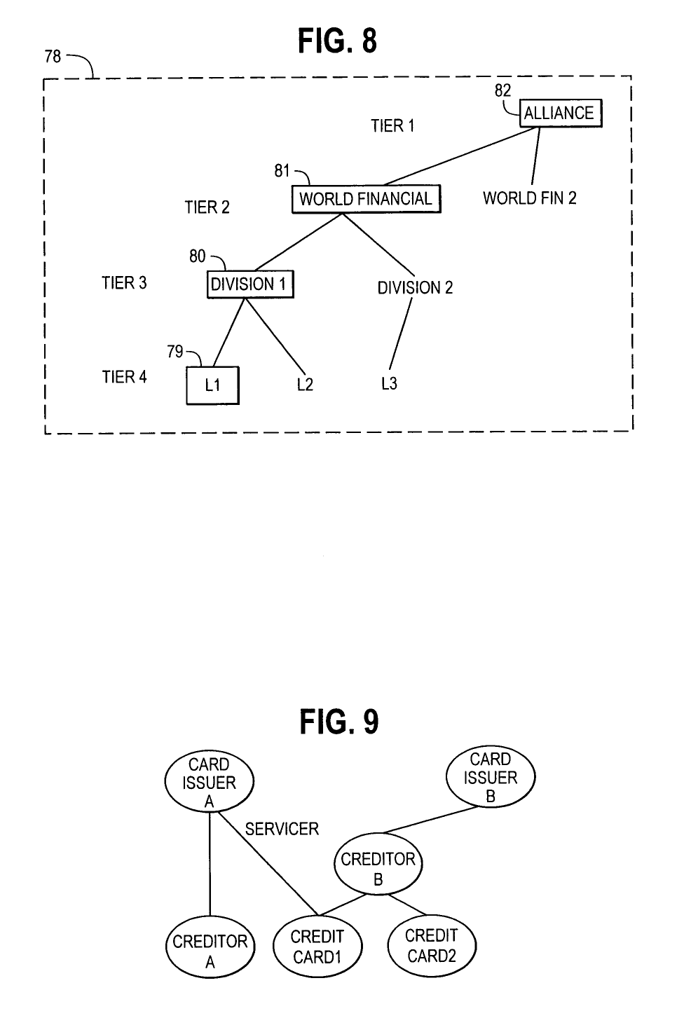

The creditor module defines and processes a creditor's profile, including address information, payments, invoices, proposals, concession information, fair share information and electronic debit or electronic funds transfer mass and biller identifications. In preferred embodiment, as displayed in FIG. 8, the system defines a hierarchal relationship 78 between creditor records. Once defined, a creditor profile is implemented throughout the entire system. Creditor relationships are used because they allow the agency to define a single set of rules that apply to multiple creditor records to increase efficiency. In addition, it allows the agency to report on all client activity for one set of creditors or for one particular creditor. The system allows for the development of as many levels of hierarchy as are required to fully describe the relationships. Utilizing the hierarchal relationship, the system automatically defines the rules for payments, invoices, proposals, concessions, etc., based on the highest tier in the hierarchy.

Nonetheless, the system is also flexible to accommodate variations of different rules at various levels within the hierarchy. For example, in FIG. 8, L1 79, in tier 4 obtains its proposal and payment rules from division 1 80 within tier 3. However, it utilizes concession rules from world financial 81 within tier 2. Moreover, it applies fair share rules from alliance 82 at tier 1.

The system also adjusts payments, proposals and various other rules based on servicer relationships (see FIG. 9). This is necessary in situations where one distributor distributes various credit cards, however, it utilizes different servicers to process payments for each credit card. In such an instance, the system automatically adjusts payments and all relevant rules based on the appropriate servicer. FIG. 9 illustrates one such exemplary relationship where a card issuer employs a servicer to handle various cards with rules relating to payments. The examples of FIGS. 8 and 9 are only examples of rules that may be used to define various payment parameters as are know to those skilled in the art. For example, existing relationship data may be used to define rules used to generate the payment parameters. Other parameter rules may also be used.

Generally, the creditor module also allows authorized users to enter new creditor information or access pages of individual creditors. The system focuses on naming the creditor, selecting parent and servicer relationship, defining various aliases for the creditor, searching electronic debit and electronic funds transfer masks and establishing creditor contacts. Within the creditor contacts, the system lists common contacts for the creditor as well.

The system allows an authorized user to view all relationships for a particular creditor. In addition, it allows a user to define specific rules for a particular client without disturbing the hierarchal relationship between creditors for other client's. The system also allows a user to view aggregate statistics for a particular creditor. For example, a user can view a client's payment history to a particular creditor or view payments and disbursements made to a particular creditor from all of the agency's clients. In addition, the module manages electronic disbursement and electronic fund transfer biller masks. It utilizes unique masks based on the type of transaction and the type of processor.

Finally, the module allows a user to view all clients belonging to one creditor. Moreover, the system displays all actions for an active creditor including client/creditor based actions and creditor only actions. As yet another advantage of the preferred embodiment of the invention, the creditor module allows an authorized user to reassign an entire client/creditor record from one creditor to another. All client/creditor records may be reassigned at once or reassigned based on group masks without disturbing any other relationships. Finally, the module logs and tracks all changes as well as the users implementing the changes within the module.

Proposal Submission Module

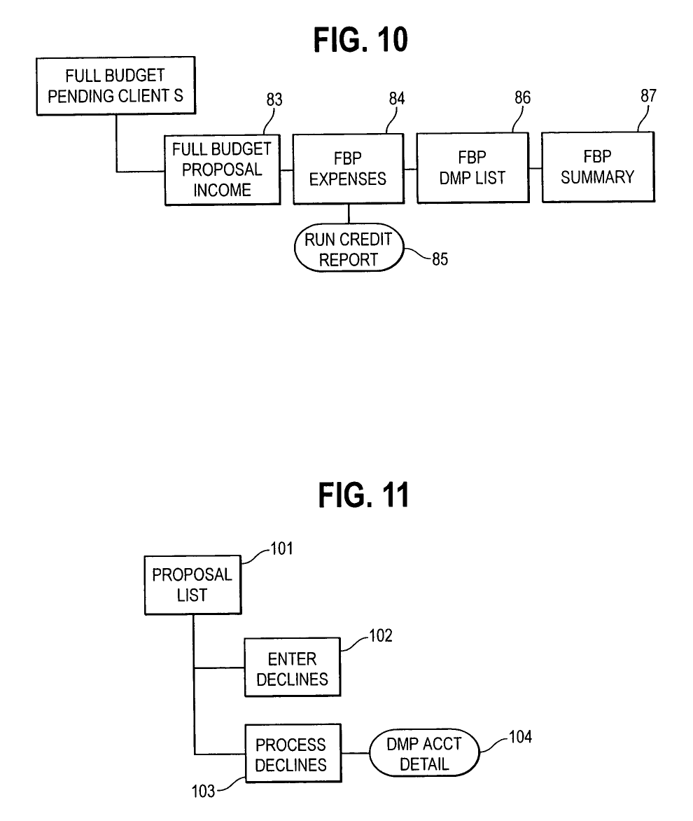

The Proposal Module processes client income, expense and creditor information to develop payment plan proposals for the creditor. The system can submit and receive proposals in electronic form as well as in print form. Referring to FIG. 10, the full budget proposal module allows a user to verify and adjust client income at a first point 83, client expenses at a second point 84, client run, credit reports at a third point 85. It displays and verifies client's debt management plan list at a fourth point 86 and generates a full budget proposal summary at a final point 87. The module is flexible because it provides a user with the ability to manage and adjust budget and payment information through full budget proposal pages prior to submitting the proposal. The module allows a user to alter specific client information. However, the system maintains the original information within the client module. It merely changes the information for budget proposals for the particular creditor as well as for related creditors.

Finally, the module tracks and processes declined proposals received from the creditors (See FIG. 11). A proposal list is generated in step 101. Declines are identified in step 102 and they are processed in step 103. The debt management plan is then detailed in step 104. Electronic responses are imported automatically and displayed on the client proposal list page. The client proposals received in print form can be added manually and displayed within the client list as well. The system further allows a user to review details of a declined proposal. Specifically, it allows a user to send a letter to client, update their debt management plan for the displayed creditor, mark the declined proposal as pending, and define reasons for the decline and add creditor comments. The system automatically generates tasks to review, correct, and resubmit the client's proposal. If a proposal is accepted, the system automatically initiates the debt management plan and processes payments and disbursements as set forth below. Therefore the module manages and processes proposal submissions in a flexible and efficient manner.

Payment and Disbursement Module

In accordance with the objects of the invention, the present invention efficiently manages and processes payments and disbursements. The payments and disbursements module is also very flexible because it provides an authorized user the ability to define set rules, define variable rules for various situations, and exceptions at particular periods or events. Generally, this module manages and processes client payment information as well as client disbursement information. It allows a user to enter service fees for a client either to the debt management plan or for process through the automatic payment system. The module directs a user to collect client debit card information where appropriate. It also allows a user to process a client's check by phone. The module allows a user to look up the payment history for a particular client. In addition, it allows users to view payment batches for specified periods, view details of particular batches, view creditor checks from various batches including creditor refund checks and batch status, view electronic funds transfers, view refunds, and view rejections. Furthermore, the module displays information about voided checks based on batch creditor voids or specific transaction voids. The system also allows a user to define payment holds during specific future points or manual holds at the present time. The system then automatically releases held funds based on review dates or after manual prompts. It refunds amounts back to client from their trust accounts if funds are available or a user prompts the system to do so. The system automatically records refunds tables and automatically updates client's accounts based on payments and funds transfer information. Finally, the system generates reconciliation reports daily based on open and closed batch processes. The system automatically adds records to reconciliation tables and posts activities based on whether payments were successful or unsuccessful.

The present invention also displays extreme flexibility during disbursements. Within this module, an authorized user can view disbursement history and edit the most recent disbursement record. The system is also sufficiently flexible to allow exceptions to disbursement rules at specified future times or current manual disbursements. A user is also able to define particular disbursement rules for specific creditors during defined times. At such an instance, the system automatically calculates and adjusts and processes disbursements to the specified creditor as well as other creditors. In addition, the system generates lists of all current creditors' invoices, displays selected invoice details and payment histories, and displays fairshare amounts for a particular disbursement. The system also displays the funds on hold, the creditor refund list, the creditor refund details, the invoice batch list, the invoice batch details, and the manual invoices. After any disbursements, the system automatically updates account balances throughout the system.

Moreover, the system manages various aspects of handling checks. The system verifies and lists cleared checks, reconciles disbursements for checks, lists check payments and displays details about particular checks. The system processes money, i.e. drafts checks, from client or creditor accounts. Thus, the system and particularly the module, manages and processes various aspects of disbursements.

Most significantly, the payments and disbursements module can collect a sum payment from the client or aggregate numerous smaller payments from various times. For example, the system can electronically debit the entire payment from a client's account at the end of the month or debit half payments every two weeks. The system then disburses this sum amount based on various rules. In one embodiment, the system can distribute the sum equally to all creditors. In another embodiment, the system can be defined to distribute the sum according to creditor preferences. For example, minimum payments can be made to particular creditors while preferred creditors receive more than the minimum payment amount. On the other hand, the system can be defined to make overpayments to the smaller accounts while making the minimum payments to the larger ones.

In the preferred embodiment, the system automatically disburses the largest amount to the creditor with the smallest account while paying the minimum for the rest of the creditor accounts. In the preferred embodiment the present invention also pays particular creditors the minimum payment to preferred creditors while making less than the minimum payment to the rest of the creditors. In the case where a client makes less than the minimum required payment, it automatically calculates and disburses minimum payments to all creditors except one. During consecutive periods of short payments, the system automatically rotates the creditors which will not receive the minimum payment. This is important because it prevents client defaults with creditors by avoiding short payments to creditors during consecutive months. Therefore, the agency is able to maintain a client's proposed payment plan with a creditor while allowing the client to make less than the total minimum payment during times of hardship such as unemployment, or divorce. This also increases client retention for the agency and maximizes fairshare to the agency from the creditors.

Action Management Module

The action management module automatically generates and assigns routine tasks associated with certain events during credit counseling. For example, the module automatically generates reminders for counselors one day prior to their scheduled appointments. Furthermore, the module automatically generates tasks for verification of creditor information or biller identification where payments, disbursements, or fair shares are rejected or unverified. Additionally, the module automatically generates tasks to particular counselors or entire groups when clients are unable to meet the minimum payment or where discrepancies during payments are created. The module also allows operators or counselors to assign specific tasks to specific individuals or specific tasks to entire groups. These assignments can be based on individual counselor's information or group characteristics such as location. The module allows users to simply reassign tasks while the system automatically adjusts the appropriate schedules. Hence, the present invention provides several advantages over conventional systems.

The system of the preferred embodiment utilizes several modules, programs that collect, store, or process data, to efficiently and accurately manage credit counseling and debt management information. Different modules are stored or utilized at different tiers within the system. For example, client information is stored within the database tier while the information is processed by the business tier.

The specific embodiments discussed in the detailed description are merely illustrated of specific ways to make and use the invention and do not limit the scope of the invention.

I claim:

1. A credit counseling and debt management system, comprising in combination,
a means for collecting client information;
a means for collecting creditor information, where said means stores said creditor information in relationships to other creditor records; and
a means for processing payments and disbursements utilizing said client and said creditor information, where said means for processing payments has the ability to automatically disburse a sum payment based on desired distribution schemes.

2. A credit counseling and debt management system as in claim 1, where said means for collecting client information automatically presents information and client solutions based on said client information.

3. A credit counseling and debt management system as in claim 1, where said creditor information is stored in relationships to other clients and industry customs.

4. A credit counseling and debt management system as in claim 1, where said means for processing payments can collect one sum payment from various sources.

5. A credit counseling and debt management system as in claim 1, where said means for processing payments and disbursements automatically rotates which creditor is paid less than the minimum payment each disbursement period.

6. A credit counseling and debt management system as in claim 1, further comprising a means tracking workers' schedules, where said means automatically displays schedules based on worker criteria and automatically adjusts scheduled times based on client criteria.

7. A credit counseling and debt management system as in claim 1, further comprising a means for automatically generating and assigning tasks to workers based on client needs and counseling events.

8. A credit counseling and debt management system as in claim 1, further comprising a means for automatically generating debt management proposals based on said client information and said creditor information.

9. A credit counseling and debt management system comprising, in combination,
a client information module;
a creditor information module, where information for each creditor is stored in relation to other creditors;
a payment and disbursement module, where said payment and disbursement module collects payments as one sum payment from various sources at various times and automatically disburses said sum payment based on desired disbursement schemes; and
a schedule module, where said schedule module tracks workers' schedules, automatically displays schedules based on worker criteria, and automatically adjusts scheduled times based on client criteria.

10. A credit counseling and debt management system as in claim 9, where said client information module automatically determines solutions to client problems based on client responses to questions.

11. A credit counseling and debt management system as in claim 10, where said payment and disbursement module automatically rotates creditors that are paid less than the minimum payment each disbursement period.

12. A credit counseling and debt management system as in claim 11, where said payment and disbursement module automatically adjusts disbursements to deduct fairshare or concessions.

13. A credit counseling and debt management system as in claim 12, further comprising a proposal module, where said proposal module automatically generates a payment plan based on payroll schedules.

14. A credit counseling and debt management system as in claim 13, further comprising an action management module, where said action management module automatically generates and assigns various tasks to workers based on client needs and counseling events.

15. A method of electronic payment and disbursement comprising the steps of:
electronically collecting small payments from various sources at various times;
electronically combining said small payments as a sum payment into a trust account; and
automatically disbursing said sum payment based on desired disbursement schemes.

16. A method of electronic payment and disbursement as in claim 15, where said disbursement scheme rotates creditors that are paid less than the minimum payment each disbursement period.

17. A method of electronic payment and disbursement as in claim 15, further comprising the step of automatically adjusting disbursement based on fairshare and concession rules.
